(19) United States
(12) Patent Application Publication
(10) Pub. No.: US 2025/0299270 A1
(43) Pub. Date: Sep. 25, 2025

(54) SYSTEM AND METHOD FOR WATER TREATMENT INCENTIVE

(71) Applicant: ORIGINCLEAR, INC., Clearwater, FL (US)

(72) Inventors: T. Riggs ECKELBERRY, Clearwater, FL (US); Kenneth BERENGER, JR., Murrysville,, PA (US)

(21) Appl. No.: 18/863,008

(22) PCT Filed: May 5, 2022
(86) PCT No.: PCT/US2022/027917

§ 371 Date: Nov. 5, 2024

(51) Int. Cl. G06Q 50/06; C02F 1/00; G16Y 10/35

(52) U.S. Cl. CPC G06Q 50/06; C02F 1/008; C02F 2201/008; C02F 2209/008; C02F 2209/40; G16Y 10/35

(57) ABSTRACT

A water treatment system includes a water treatment station having a water input and a water output, an input sensor measuring an input flow and an output sensor measuring an output flow, and a connection through a network to a computer. A blockchain includes a plurality of user's terminals, a ledger for registering peer to peer transactions and a program enabling peer to peer transactions between the terminals by exchanging tokens through a consensus mechanism. The computer having access to the blockchain. The information issued by the input sensor and by the output sensor are transmitted to the computer. The computer associates a given number of the tokens based on the information supplied by the sensors. Preferably, the tokens can be associated with revenue streams as dividends and through transferability, create a financial marketplace.

### RELATED APPLICATIONS

This application is a § 371 application of PCT/US2022/027917 filed May 5, 2022, which is incorporated herein by reference in its entirety.

### TECHNICAL FIELD

The invention relates to water treatment and more particularly to water treatment as a service.

More specifically, the method of the invention aims at sharing the cost of water treatment among a plurality of actors and to provide incentives to set up state of the art water treatment installations.

The invention also relates to a method for the management of a scarce resource, like clean water, among a community of states, counties, cities or private parties sharing this resource.

### BACKGROUND OF THE INVENTION

Clean water is becoming a scarce resource in some areas/states, because of drought, over exploitation of aquifers e.g. for farming, uneven rain precipitation connected to global warming side effects, population growth, industrial pollution.

Access to clean water is vital to the public health, welfare and economy.

In this framework preserving the resource by avoiding the rejection of polluted water is of primary importance.

Most of the water used in human activities, whether industrial, personal or agricultural requires treatment that may consist in pre-treatment or purification, effluent or post treatment, and process reuse or recycling, or a combination thereof.

Water treatment installations are expensive investments, that last for decades.

Purification takes a water from a source that may be as for instances the environment or municipal water and aims at making it suitable for its intended use. Other steps such as mineralization may occur.

Effluent treatment aims at making the water or a mix of water and contaminants suitable for its release after use in, e.g., the environment or a municipal sewer.

Process reuse or recycling makes use water after a first use to make it suitable for up to multiple reuses.

Depending on the scale of observation, like the scale of a specific process, of a household, of a plant, of a city, of a country each type of water treatment may be considered of any of the above 3 and actually may be a combination of the 3 depending on the observation point.

Ultimately, water is taken from the environment and reintroduced in the environment. But even when considering this overall scheme, City A may pump water in or from an aquifer, part of this water is used, e.g., by citizens and released as wastewater to the sewer, where it is treated before being released in the environment e.g. in a river. City B pumps water from the aforesaid river and purifies it before dispatching it to its citizens etc.

What is called “water consumption” is actually a cycle. In such a cycle virtuous consumption is when water spoiled by human activity, whether industrial or individual, is released to the environment as clean as it was extracted from this environment.

Harmful consumption is when water is released untreated in the environment.

The latter may have deleterious effects and may affect a much higher quantity of water than what was actually released, as well as affecting areas remote from the spill. As a for instance, on Jan. 30, 2000, a gold and silver extracting plant in Bala Mare (Romania) accidentally released polluted water containing sodium cyanide and other substances in a nearby river. The polluted water travelled during 14 days and over 800 km in various rivers down to the Danube River and the Black Sea, killing all water life over its travel and making the water unsuitable for common usage for months in neighbouring countries.

Without going that extreme, poor effluent treatment by one user may significantly affect the cost of the purification by another.

These issues are commonly addressed through regulations. However, regulations do not provide incentives to go beyond and are based on a compromise that may not be suitable for a specific case or a specific community. In the example of Cities A, B and C pumping their water consumption and releasing their wastewater in the same river, City C that is downstream of City A and City B, may experience higher pre-treatment and post-treatment costs than Cities A and B even if the latter strictly respected the regulations.

Moreover, water treatment emits CO2 mainly from operational energy use. Tightening the regulations in order to improve water quality, may result in an increase of carbon emissions connected with water treatment. Although, some type of treatment may be less emissive than others, as mentioned above, those installations are expensive and long lasting. There are currently no incentives or mechanism for a company to change or upgrade a water treatment installation in order to reduce carbon emissions, liable to result in a long enough lasting payback to make such an upgrade economically sound. As a result, the cost of such an upgrade ends up being paid by the end user, although beneficial on a world scale level.

To give an order of magnitude, in a country like England, water treatment accounts for 11 million metric tons of CO2 emissions per year. In a country like France water treatment accounts for 2% of the overall GHG emissions.

### OBJECT AND SUMMARY OF THE INVENTION

The invention pertains to a system and a method enabling traceability of an individual water quantity (e.g., a gallon) along a single or chained water treatment stations of various types.

To this end, the invention uses blockchain technology as well as smart contracts to follow, in a virtual space, the trading involved in a water treatment system and to trigger selected actions based on token exchanges and rules implemented in smart contracts among the users and/or between the water treatment stations themselves.

Throughout the text “water treatment” shall be understood in a broad sense, and, although mostly concerned by the removal of contaminants from water, extends to any operation in a water distribution system including simple pumping, conveyance and discharging.

The person skilled in the art understands that although the invention is disclosed in the framework of water treatment, it may apply to other resources sharing common characteristics without departing from the invention. Nonlimiting examples of resources or treatments that may use the system and the method of the invention or part of, are forestry, halieutics resources (aquaculture), municipal waste, GHGs, etc.

From an overall point of view, the invention aims at managing streams and stock of a resource that cannot be, or hardly be, appropriated, sometimes referred to as common goods, or involving natural processes beyond human capabilities for their renewal, their creation or their purification. However, in some embodiments, the invention may be limited to the management of streams or to the management of the stock.

More specifically, the system of the invention comprises:
a water treatment station having a water input and a water output and supplied with an energy source;
an input sensor measuring an input flow at the water input and issuing an input information accordingly;
an output sensor to measure an output flow at the water output and to issue an output information accordingly;
a quality sensor measuring a water quality parameter at the water output and to issue a quality information;
a connection through a network to a computer;
a blockchain comprising a plurality of users as terminals, a plurality of tokens, a ledger for registering a peer-to-peer transaction between two terminals and a program enabling a peer-to-peer transactions between terminals by exchanging a token through a consensus mechanism and recording the transaction in the ledger;
the computer having access to the blockchain;
wherein the input information issued by the input sensor, the output information issued by the output sensor and the quality information issued by the quality sensor are transmitted to the computer via the network and wherein the computer associates the token in a given number based on the information supplied by the sensors.

Thus, each gallon (or any other quantity) of water treated by the water treatment station is associated to a token that enables trading between the terminals connected to the blockchain.

The invention is advantageously implemented according to the following nonlimiting specific embodiments, that can be considered individually or according to any technically operative combination thereof.

Advantageously, the terminals connected to the blockchain between which transactions may occur comprise terminals owned by stakeholders of a water treatment system.

According to an embodiment, the system comprises tokens of the Nonfungible Token (NFT) type. NFTs are attributed to a specific type of water gallons giving them a warranty of origin. Such a warranty of origin may be connected to a geographical location, a particular type of treatment, a specific purity or pollution index, i.e., from an overall point of view is reflecting a quantity or specific state of the water in terms of whether good or bad quality, depending on the foreseen implementation; potentially related to the cost of the original investment in the water treatment system and bearing pro rata income therefrom. An NFT can be minute (i.e. representing as little as one gallon with no subdivision) or very large, with the ability to break off fractions which will be in themselves unique.

According to embodiments, the water treatment station may be of the fixed type, e.g., a water treatment plant or of the mobile type, e.g., a water treatment trailer or container.

Advantageously, the water treatment station comprises a geolocation device and the geolocation information is transmitted to the computer along with the information issued by the sensors.

According to an embodiment, the system of the invention comprises a quality input sensor or a quality output sensor measuring parameters characterizing the water, the aforesaid parameters are transmitted to the computer.

In such an embodiment, the quality input sensor or the quality output sensor are measuring at least one parameter among:
temperature,
Ph,
Calcium content,
Nitrates content,
Chlorine content,
heavy metal content,
turbidity and Total Suspended Solids,
Total Dissolved Solids,
Biological Oxygen Demand,
Chemical Oxygen Demand,
Specific molecules such as arsenic or polyfluoroalkyl substances (PFAS),
microplastic content
without this list being limiting.

Depending on the application and on the parameter, these measurements may be carried out “on the fly” or on a periodical basis. In this latter case, they may be associated with a set of tokens that are associated to a given quantity of treated water either before or after the measurement, and they may be tied to the pro rata revenue share associated with that quantity in such a way that the NFT bearer inherently receives the pro rata revenue.

All this information is recorded in association with the token.

Advantageously, each recorded association with a token is date-stamped by the computer.

According to an embodiment, the water treatment station also comprises an energy consumption sensor and transmit this information to the computer along with the type of energy source.

Accordingly, eventually by combining this information with the geolocation information and the date information, the carbon footprint of the corresponding treatment is determined and recorded in association with the token.

The way the tokens are associated to a given quantity and quality of water as well as the type of token, whether utility or NFT, and the way the transactions involving tokens are carried out between the stakeholders are defined in smart contracts, the corpus of which ruling the blockchain being also known as “lex cryptographica”.

To this end, the system of the invention comprises a program known as a smart contract that rules the conditions of a transaction between two or more terminals connected to the blockchain as well as the conditions to trigger such a transaction.

A transaction may consist in an exchange where a first given amount of tokens of defined type are credited to the benefit of one stakeholder and a second given amount of token of a defined type are debited at the expense of another stakeholder, or may result in a destruction of tokens, or may consist in the substitution of a certain amount of tokens of one category with another amount of tokens of another category, whether each amount belongs to the same stakeholder or to different stakeholders, or combination thereof. A token may also be switched to an “off state” at the end of life of the water treatment system it represents.

The invention also pertains to a method implementing the water treatment system of the claimed invention. A terminal A and a terminal B, respectively, held by stakeholder A and stakeholder B are connected to the blockchain. A smart contract defines the cost in tokens of a given transaction between terminal A and terminal B. The transaction being triggered by an event defined in the smart contract. The method comprising the steps of:
sending a request via terminal A triggering the event;
upon receipt by terminal B, validating the transaction through the consensus mechanism;
debiting or crediting tokens from terminal A to terminal B according to the terms and conditions of the smart contracts; and
recording the transaction in the ledger.

According to an embodiment, a fixed quantity of tokens are allocated over a given time frame to the stakeholders, each association of information to a token decreasing the available quantity.

According to a variant of the latter, a fixed quantity of tokens is allocated over a given time frame to each stakeholder individually.

According to an embodiment the allocated tokens are automatically destroyed after a given time past their allocation if they are not associated.

Allocating a fixed number of tokens, along with the regulation of their association and trade through smart contracts, enables an authority, whether at a state level or at a community level to implement environmental policies and to provide incentives for virtuous consumption or for resource savings.

### BRIEF DESCRIPTION OF THE DRAWINGS

The invention is disclosed hereafter according to one of its embodiments, in no way limiting, and in reference to FIGS. 1 and 2 wherein:

FIG. 1 shows schematically the components of the system, and

FIG. 2 sketches how the system of the invention may be advantageously used to create a marketplace and investment incentive.

### DETAILED DESCRIPTION OF THE EMBODIMENTS

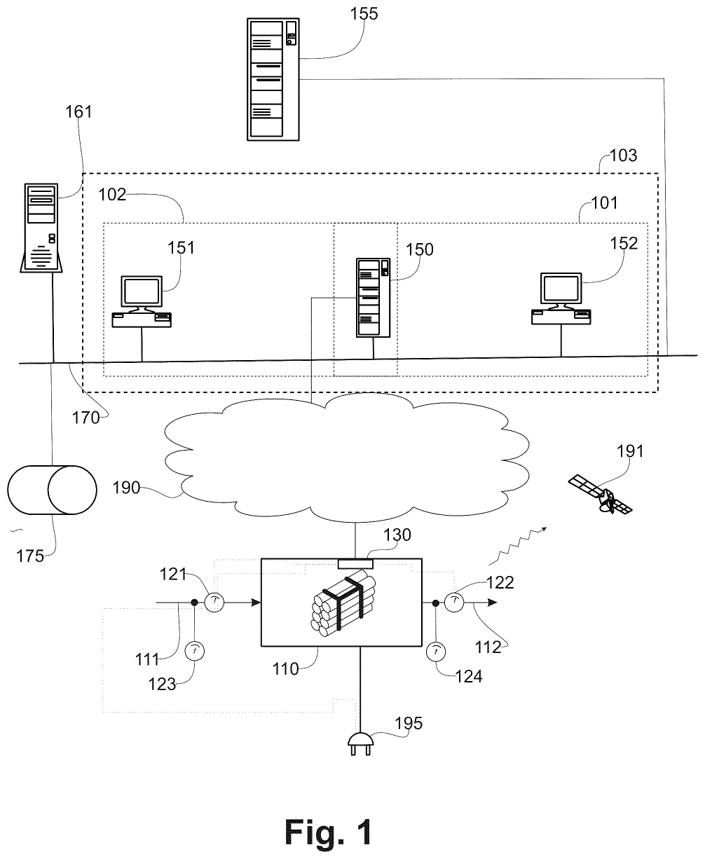

FIG. 1, according to an exemplary embodiment, the elementary components of the system of the invention comprises a water treatment station (110). An incoming stream (111) of water enters the station and an outgoing stream (112) of water is leaving the station after being treated.

The incoming stream (111) may come from a pumping in a natural resource like an aquifer or may be the output stream of another water treatment device, as for instance, when the water treatment station (110) performs a pre-treatment or purification of municipal water in order to make it appropriate for a specific industrial process.

The outgoing stream (112) may be discharged in the environment or may be the incoming stream of a further treatment performed by another water treatment station.

As it can be understood from the above, the water treatment station may be the unique link of a chain or may be a link in a much wider chain of water treatments, connected in series or in parallel or combination thereof, the length of this chain being dependent upon the scale of observation.

The water treatment station (110) may be of a fixed type or may be a mobile device, as for instance, it may be set in a trailer or on a truck and be moved from one location to another to perform a specific treatment.

Once again, in each location, the water treatment station may be considered alone or may be inserted in a wider treatment chain.

The water treatment station (110) is geolocated through a satellite (191) positioning, like the GPS, by way of a cell phone network, or any other type of beacon known from the prior art.

The water treatment station is connected in its location to a power source (195). Such a power source may be electricity from the grid, energy provided by any other source like solar panels, a generator, a battery or a fuel cell without this list being exhaustive.

Depending on the nature of this power source, the location of the water treatment station and the date, the energy supplied through this power source has a given carbon footprint, that may vary over time.

An input sensor (121) measures the incoming flow of water to be treated in the water treatment station.

An output sensor (122) measures the outgoing flow of treated water.

According to an embodiment the water treatment station comprises one or more additional sensors known as quality sensors (123, 124) measuring in the incoming stream and/or in the outgoing stream, any of the information comprising:
temperature,
Ph,
Calcium content,
Nitrates content,
Chlorine content,
heavy metal content,
turbidity and Total Suspended Solids,
Total Dissolved Solids,
Biological Oxygen Demand,
Chemical Oxygen Demand,
Specific molecules such as arsenic or polyfluoroalkyl substances (PFAS), and
microplastic content.

Or any combination thereof, the information issued by each sensor (121, 122, 123, 124) is transmitted via a wired or wireless connection, or combination thereof, to a communication module (130).

To this end, the water treatment station comprises a communication module (130) gathering the various information, including the information issued by each sensor, the power consumption, the geolocation, and, according to an exemplary embodiment, sends them through a network (190) to a computer (150).

The computer comprises a memory, a processor and hosts computer programs.

The computer (150) is connected as a terminal to a blockchain (170).

A blockchain sets a relation through one or more networks between a plurality of terminals (150, 151, 152) for the purpose of performing peer-to-peer transactions between those terminals.

The blockchain technology is known from the prior art and will not be described in detail.

In a nutshell, for a blockchain to work it needs a tamper-proof ledger (175), which is actually a kind of database recording the transactions as blocks and stacking (chaining) the blocks on one another so that one block cannot be tampered unless the whole chain is modified, a consensus mechanism that proves a legit transaction between two terminals, and programs implementing the consensus mechanism and the writing in the ledger.

A blockchain is decentralized by nature and does not require a central server. Therefore, it can grow to any size, and an image of the blockchain comprising the stack of transactions, is replicated on each terminal, so that the system is robust and may be rebuilt even after a major outage, provided that at least one terminal is still existing.

According to an embodiment and as implemented by the system of the invention, a transaction between terminals is performed through tokens.

Tokens are virtual entities circulating in the blockchain through transactions. A well- known example of such an entity is BITCOIN® although blockchains are in no way limited to cryptocurrencies and to buy and sell transactions.

The terms and conditions of a transaction in a blockchain are defined by computer programs also known as a smart contract.

A smart contract triggers a transaction upon the occurrence of an event, such an event being internal to the blockchain or taking place outside of the blockchain, but the information of its occurrence being input in the blockchain.

Such a transaction may be an exchange of tokens between a debtor and a creditor, a destruction or burning of tokens, the substitution of one kind of token by another kind of token as described hereafter, or the creation or minting of tokens.

As mentioned in the case of the ledger (175), once implemented, the smart contract is tamper-proof, cannot be abused and cannot be modified unless it is coded accordingly and when the run of another smart contract enables such an amendment.

As a consequence, a specific kind of transaction, not involving tokens, consists in an amendment of the terms and conditions of an existing smart contract, in the limit of the coded capabilities of such an amendment.

Like the ledger, the smart contracts are not stored and executed from a central server but are replicated on each terminal of the blockchain, and therefore cannot be easily tampered with, for instance through a cyberattack; and are tamper-proof from a practical point of view.

The corpus of smart contracts in a blockchain defines a law ruling the transactions in such a blockchain and is sometimes referred to as “lex cryptographica”.

According to an exemplary embodiment, the system comprises a specific terminal (155) gathering and centralizing initial transactions with one or more water treatment stations and their associated computers (150), such specific terminal (155) is thus a supervising terminal of the water treatment system.

Turning back to FIG. 1, the specific programs hosted by the computer (150) and known as smart contracts, associate a given number and a kind of tokens with the information supplied to the computer by the communication module (130).

Such an association is performed through a transaction and according to a variety of embodiments may be made through a debit and credit mechanism, through the creation of tokens, through the destruction of tokens from an initial stock, or through the substitution of tokens of one kind by another kind.

We give some nonlimiting examples hereafter but the person skilled in the art understands that the principles may applied to a large variety of cases.

As a for instance, the supervising terminal (155) owns a batch of tokens, initially acquired through investors, and sends (credits) a given number of tokens to the computer (150) depending on the information supplied and the smart contract.

Beside the computer (150) shown connected to the water treatment station (110) the other terminals (151, 152) are connected to other water treatment stations implemented by stakeholders of the overall water consumption and treatment chain.

As already mentioned, the terms “water treatment” shall be understood in a broad sense and are actually “stations” through which a water stream is flowing.

As a for instance, an end user consuming tap water and rejecting it in its backyard and in the sewer is a “water treatment station”. Therefore, the blockchain connects stakeholders of a physical water treatment system the extent of which is in theory limitless but may be organized in cells.

In this exemplary embodiment, a cell (101, 102) may gather a plurality of stakeholders represented by their terminals (150, 152) on the blockchain.

In a given cell (101, 102), which may correspond to the stakeholders of a specific community, the relationships/transactions between these stakeholders are defined by a combination of smart contracts some of them affecting only or having specific terms and conditions for the stakeholders of this very cell, and others affecting the entire blockchain.

According to the exemplary embodiment depicted in FIG. 1, different cells (101, 102) may include other stakeholders represented by their terminals (150, 151). Therefore, two cells may have some stakeholders in common, and such stakeholders may be ruled by a plurality of different lex cryptographica.

As it can be understood, the rules pertaining to a small cell may be more detailed and specific than the rules defining the relationship between cells.

In addition, a supercell (103) gathering a plurality of subcells (101, 102) may be defined according to geographical or other considerations. Consequently, the whole water network, for example at a country level, may be represented in a virtual space by a blockchain organized in interconnected cells and supercells, with regulations, some of them being locals and others spreading over the whole network.

The transactions, between cells or supercells are ruled by smart contracts defined at the appropriate cell level.

Each terminal is identified by a unique identifier and a single or a plurality of cells memberships, each cell is defined by an identifier and a single or a plurality of supercells memberships and so on.

According to a specific embodiment another kind of terminal (160) may be connected to the blockchain (170). Such a terminal (160) is not directly part of the water treatment system and is used to connect the blockchain to “out of the water network” type of transaction. As an exemplary embodiment the aforesaid terminal may allow a financial service provider to acquire or exchange tokens.

According to an embodiment, the token circulating in the blockchain and involved in the transactions ruled by the smart contracts are of two types.

A first type is called a utility token. Such a token is an intangible asset, and to some extent, can be compared to a cryptocurrency like BITCOIN®.

The other type is called a Nonfungible Token or NFT. Although a token is intangible in nature, a NFT may be associated with an identified asset or treatment. By identified, it shall be understood any or all of:
A geographical location,
A specific type of water treatment,
A treatment date,
A specific delivered water quality (assessed by the sensors),
A specific type or a specific water treatment installation.

The list being nonlimiting.

As an example of the way those tokens may be used, an investor wishing to invest in a water treatment system, the aforesaid investor being environmentally conscious and wishing to favour high quality water treatments, or low carbon footprint treatments, or treatments of water contaminated by heavy metals or in a specific geographic area, will purchase utility tokens assorted with its requirements.

By purchasing these tokens, the investor provides funds for implementing water treatment installations, said tokens being not specific to a single material installation.

According to his exemplary embodiment, although the investor expressed requirements associated with its investment, those requirements are not attached to the token he purchases, which are “requirement blind” but defined in a smart contract.

According to the requirements of the investor, when either new or existing installations fulfilling those requirements are run, the associated tokens are of the NFT type, meaning they are specifically associated with any or all of a date, a treated water quality, a geographical location, a carbon footprint and so on.

The NFTs fulfilling the requirements of the investor, will be substituted to the utility tokens owned by the aforesaid investor through one or more smart contracts and associated transactions, said now generic utility tokens being once again available for sale to another investor with other requirements.

It shall be understood that the NFTs substituted to the utility tokens may come from a plurality of cells or supercells provided that they fulfil the requirements of the investor.

Actually, the investor invests in a treatment capability, as a share of the water treatment system expressed as an invested asset, a quantity of treated water fulfilling its requirements and not necessarily a quantity of water that he will consume itself or even that will be consumed in its living area, The investor may even be living in another country.

On the other hand, the treated water fulfilling the requirements and generating the NFTs is also invoiced to an individual or to a community.

From an overall point of view, as the scarcity of quality water is worsening with time and as the regulations are tightening, the cost of such a treatment increases. This cost may be embedded in an end-user subscription agreement as a cost-of-living adjustment.

As a result, an investor purchasing a large quantity of utility tokens with tight requirements will likely pay less for those utility tokens than the total lifetime revenue from the underlying asset. Therefore, the token has inherent value beyond its face or initial value, and there is a profit that may be shared between the investor and other stakeholders like the company operating the water treatment installation.

These profits may be paid to the investor in the form of additional utility tokens, of another cryptocurrency or even in fiduciary currency.

This way, the stakeholders of a water treatment system may raise funds in order to continuously improve the aforesaid system.

In other words, in this exemplary embodiment, the utility tokens purchased by the investor that correspond to an investment in a water treatment system, generates a revenue stream to its profit, depending on the quantity and the quality of water treated.

As for the requirements, those may be proposed by a management authority of the water treatment system in predefined bundles corresponding to different levels of investments, revenue streams and accordingly to different performances in water treatment, each bundle is associated to a predefined smart contract implemented in blockchain.

Since the utility tokens purchased by the investor are not connected to any specific installation, but actually to the performance of the whole network covered by the blockchain, the tokens may be freely transferred to another party without affecting the ownership of the equipment they finance.

In fact, each token includes the entirety of all future profit shares that an investor has a pro rata right to.

The above example is not the only way of using the system of the invention.

As another exemplary embodiment that is fully compatible with the aforementioned example, the system of the invention may be used to manage a water resource among stakeholders.

To this end, as for instance, a ruling authority allocates, through the supervising terminal (155), a fixed amount of tokens to the stakeholder of one or more cells.

This fixed amount of tokens may be allocated for a given time frame, meaning that those tokens are, as an example, automatically destroyed past a given time after their allocation.

Through a specific transaction the authority implements rules among the stakeholders through the amendment of smart contracts. Those rules may set the destruction time frame of the allocated tokens, or the number of tokens consumed or substituted depending on the parameters associated with the water treatment tokens.

If the initially allocated tokens are representing the yearly quantity of water a stakeholder of a water system is allowed to pump in a resource, the stakeholder water consumption may be deducted at a pace depending on the quality of the water treatment implemented by the stakeholder or stakeholders belonging to the same cell.

As a for instance, if the post treatment provides water of high quality, which is measured in real time by the sensors, one gallon of consumed water results in the destruction of one allocated token.

However, if the post-treatment is of poor quality or if the water is not post-treated before being released in the environment, one gallon of consumed water results in the destruction of 2 or 1.5 initially allocated tokens.

All these transactions are performed automatically, in almost real time through smart contracts.

Once a stakeholder or a group of stakeholders do no longer own allocated tokens, it shall acquire such tokens from another stakeholder belonging to the same cell or to neighbouring cells.

To this end the system of the invention comprises, at the blockchain level, a digital auction mechanism, where prudent stakeholders saving water and/or implementing high end water treatment may be rewarded by conceding their saved rights to others.

The person skilled in the art understands that combining such auction mechanism with the fundraising mechanism may help a community to implement cutting edge water treatment and water management service by financing these services on the fly.

Additionally, the system of the invention comprises a specific computer programme, i.e., smart contract, that is intended for conflict resolution. Such a programme may be used to amend or to stop the performance of smart contracts that have been coded accordingly and may be triggered and implemented through a specific terminal (160) by an arbitration authority.

The exemplary embodiment disclosed hereinabove show that the invention achieves its intended aims by providing the users of the system and the method of the invention strong incentive for a continuous improvement and lean management of a water treatment system.

It shall be understood that each token may be connected, in real time to a small quantity of treated water, namely a gallon or a quart, such a granularity being enabled by the automation provided by tokens and smart contracts. Alternatively, the token in an NFT expression may represent a very large amount of treated water, with the inherent NFT fractional capability representing small quantities.

In particular, the system and the method of the invention allows micro-parts of larger investments and micro-parts of larger payments, in a capital-intensive domain, those financial streams being strongly geared to the performance of a water treatment system, by automated all these transactions.

Such a micro financing, solving a macro challenge would not be possible with conventional means, i.e., without the blockchain, as dividend account updates would be required in a back office, with the usual errors, customer service problems, etc., and basically the profits would be absorbed by the required accounting and management structure.

Without the blockchain and the advantages provided by tokens and smart contracts such a micro-investment would be difficult to implement beyond the local level.

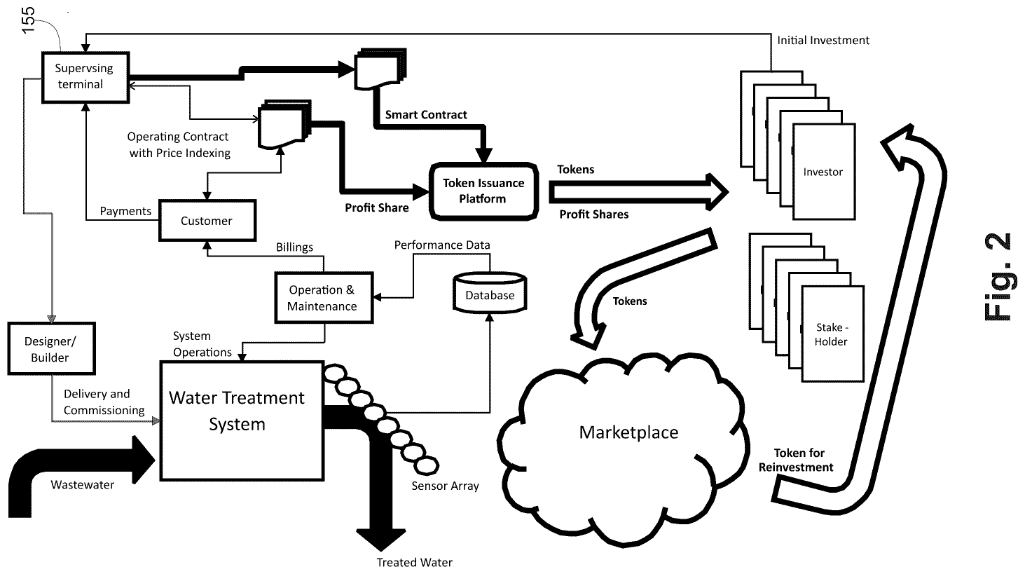

FIG. 2 illustrates the system of the invention advantageously implemented to set up a marketplace where NFTs or tokens represent water treatment revenues, which due to water rate inflation, desertification and dollar inflation, predicated to increase in value, creating a basis for secondary market pricing, leverage, options and other financial market devices.

According to this exemplary embodiment, the water treatment system is financed by an initial investment that translate into tokens bought upfront by investor, as for instance in an ICO: “initial coin offering”’.

The initial number of issued tokens depends on the implementation cost of the water treatment system as well as on the expected volume of water to be treated during a given amortization time frame.

In an exemplary embodiment, NFTs are generated according to the volume and quality of water treated and the conditions defined in smart contracts.

Turning back to FIG. 1, in such embodiment, NFTs are created through a transaction on the blockchain between the computer (150) and the supervising terminal (155).

Such NFTs may further be transferred to investors and stakeholder associated with a value.

Investors and stakeholders may place those NFTs on the marketplace.

As a consequence, NFTs may characterize the contribution of their holder to the investment in the water treatment systems and the consequent stream of payments as for instance, revenue shares or dividends.

1. A water treatment system, comprising:
a water treatment station having a water input and a water output and supplied with an energy source;
an input sensor measuring an input flow at the water input and issuing an input information accordingly and an output sensor measuring an output flow at the water output and issuing an output information accordingly;
a quality sensor measuring a water quality parameter at the water output and issuing a quality information;
a connection through a network to a computer;
a blockchain comprising a plurality of users as terminals, a plurality of tokens, a ledger for registering a peer to peer transaction between two terminals and a program enabling a peer to peer transactions between terminals by exchanging a token through a consensus mechanism and recording the transaction in the ledger;
the computer having access to the blockchain; and
wherein the input information issued by the input sensor, the output information issued by the output sensor and the quality information issued by the quality sensor are transmitted to the computer via the network and wherein the computer associates the token in a given number based on the information supplied by the sensors.

2. The water treatment system of claim 1, wherein the terminals connected to the blockchain between which transactions may occur comprise terminals owned by stakeholders of a water treatment system.

3. The water treatment system of claim 1, wherein the token is of the Non-Fungible Token (NFT) type associated to the water treatment station as a warranty of origin.

4. The water treatment system of claim 1, wherein the water treatment station is of the fixed type.

5. The water treatment system of claim 1, wherein the water treatment station is of the mobile type.

6. The water treatment system of claim 1, comprising a geolocation device and wherein the geolocation information is transmitted to the computer along with the information issued by the sensors.

7. The water treatment system of claim 1, comprising a quality input sensor measuring a water quality parameter at the water input and issuing an input quality information transmitted to the computer.

8. The water treatment system of claim 7, wherein the quality input sensor and the quality output sensor are measuring at least one parameter among:
temperature,
Ph,
Calcium content,
Nitrates content,
Chlorine content,
heavy metal content,
turbidity and Total Suspended Solids,
Total Dissolve Solids,
Biological Oxygen Demand,
Chemical Oxygen Demand,
Specific molecules such as arsenic or polyfluoroalkyl substances (PFAS), and
microplastic content.

9. The water system of claim 8, wherein the information issued by the quality input sensor and by the quality output sensor is recorded in association with the token.

10. The water system of claim 1, wherein the water treatment station also comprises an energy consumption sensor, the information issued by this sensor being transmitted to the computer along with the type of the energy source.

11. The water treatment system of claim 1, comprising a computer program known as a smart contract ruling the conditions of a transaction between two or more terminals connected to the blockchain as well as the conditions to trigger such a transaction.

12. A method implementing the water treatment system of claim 2, wherein a terminal A and a terminal B, respectively held by Stakeholder A and stakeholder B, are connected to the blockchain and wherein a smart contract is defining the cost in tokens of a given transaction between terminal A and terminal B, the transaction being triggered by an event defined in the smart contract, the method comprising the steps of:
sending a request via the terminal A triggering the event;
upon receipt by the terminal B, validating the transaction through the consensus mechanism;
debiting or crediting tokens from the terminal A to the terminal B according to the terms and conditions of the smart contracts; and
recording the transaction in the ledger.

13. The method of claim 12, wherein a fixed quantity of tokens is allocated over a given time frame to stakeholders A and B.

14. The method of claim 13, wherein the allocated tokens are automatically destroyed after a given time past their allocation.

15. The method of claim 12, wherein the token is of the Non-Fungible Token (NFT) type associated to the water treatment station as a warranty of origin and initially allocated tokens are of the utility token type and wherein a transaction comprises the substitution of a utility token by an NFT.
